(19) United States
(12) Patent Application Publication
(10) Pub. No.: US 2011/0265152 A1
(43) Pub. Date: Oct. 27, 2011

(54) SELF-REFRESHING DISPLAY DEVICE SYSTEM AND METHOD

(76) Inventor: Gerald Isaac Kestenbaum, New York, NY (US)

(21) Appl. No.: 12/766,665

(22) Filed: Apr. 23, 2010

(51) Int. Cl. G06F 15/16; G06F 9/24; H04L 9/32

(52) U.S. Cl. 726/5; 709/219; 713/2

(57) ABSTRACT

Disclosed is a self-refreshing display system and method that includes a computing device and a display device operatively coupled to the computing device. In a preferred embodiment, an outer frame is provided in the display device, and at least two inner frames are contained in the outer frame. The outer frame is not visible and each of the at least two inner frames is operable to alternate being visible and being not visible. Each of the at least two inner frames is operable to display the content received from the computing device. Preferably, the computing device causes a first inner frame to visibly display content received over a communication network from an information processor while a second two inner frame remains not visible. An electronic request is preferably submitted by the computing device for new and/or updated content from the information processor, and when received, the second inner frame visibly displays the new and/or updated content and the first inner frame becomes not visible.

### BACKGROUND

1. Field

The present application relates, generally, to public display devices, and, more particularly, to providing seamless and uninterrupted display of internet-based content in a public display device.

2. Description of the Related Art

The present invention incorporates by reference in its entirety commonly assigned U.S. patent application Ser. No. 09/587,525, entitled APPARATUS AND METHOD FOR PROVIDING BUILDING MANAGEMENT INFORMATION.

An ever-increasing amount of dynamically provided information is displayed in public spaces. Typically, the dynamic information (i.e., information that changes and frequently and/or periodically is updated) is retrieved from the Internet and, thereafter, displayed on one or more large publicly viewable displays.

Individual users of computers that access Internet content, such as via web browser software, usually make selections via graphical screen controls or other options displayed on web sites. For example, graphical screen icons and textual hyperlinks are selected or web site uniform resource locators (“URLs’) are manually typed that enable web browsers to obtain and display or reload Internet-based content. Non-kiosk public displays that show internet-based content, in contrast, typically do not regularly operate via input devices, such as a mouse or keyboard, for accessing and displaying content regularly. Instead, content from a desired web page or other source is accessed substantially automatically, without an individual manually making selections or typing entries. Public displays are, accordingly, self-reloading with content.

Various shortcomings exist in the prior art that interfere with or otherwise preclude information from being displayed correctly or in a timely way on a public display. One problem occurs when Internet connections are interrupted and access to the content drops. Other problems occur when the source of the information, e.g., a “host” or “server” computer, is unavailable or does not recognize the user/computer requesting access to the information.

Typical web browser software applications recognize Internet-related errors by codes when error conditions are encountered. Examples of Internet-related codes/errors include “400 Bad File Request,” “404 File Not Found,” “408 Request Timeout,” “500 Internal Error,” “502 Service Temporarily Overloaded,” “503 Service Unavailable,” “Bad File Request,” “Connection Refused by Host,” “Host Unavailable,” “Network Connection Refused by the Server” and “Unable to Locate Host.” When a prior art public display encounters these or other error conditions, self-reloading functionality ceases to operate.

As web browsers encounter errors such as those listed above, various messages may be displayed to users that are usually fairly cryptic and indicate that appropriate action needs to be taken. Unfortunately and as noted above, public displays often operate unattended while displaying cryptic messages regarding a particular error. Many public displays are not always connected to an input device such as a keyboard or mouse, thereby precluding a quick resolution of a particular error. This may also be because computing devices that are coupled to public displays are often in locations that are remote or inconvenient to access. Sometimes a computer that is coupled to a public display encounters an internal error and may restart or “reboot.” In this case and unless a connection to the host is automatically re-established, viewers will not see any updated content until the connection is manually established or restored. No information is typically displayed for users that indicates that recovery steps need to be or are being taken, nor are any recovery steps usually automatically taken.

Furthermore, there is an aesthetic concern for public displays that are provided in up-scale residential buildings. Such public displays need to provide messages to viewers in aesthetically pleasing and attractive ways. Information relating to residential building settings, such as when deliveries are made or building-related maintenance is scheduled that may impact building services needs to be displayed in an attractive way. Newly received and updated content on public displays and provided over the Internet should be displayed in smooth, seamless ways that provide a professional, clean appearance. Typical web browser software applications that load content over the Internet often do so in piecemeal ways, as information is sequentially received from a server. This impacts a smooth, aesthetically pleasing display. It is undesirable to paint the screen in stages, as the various content items are downloaded and loaded into the browser or, alternatively, if “buffering” is used on the client side, to display a blank or white screen until content is fully loaded.

One known technique to display information in organized ways in HTML documents is to use “frames.” HTML frames typically include an “outer” frame source, which represents one source of content that is displayed in the frame, often including hyperlinks to various web pages or positions (“bookmarks”) within a web page. One or more “inner” frames display web page content that corresponds to selected ones of hyperlinks within the outer frame. Thus, an outer frame displays a series of hypertext links, and an inner frame displays a web page that corresponds to a respective link that is selected by a user in the outer frame. The use of frames in web browser applications, accordingly, provides for the display of content from two different web page sources (e.g., an outer frame displaying hyperlinks and an inner frame displaying content from which one of the hyperlinks relate) concurrently on a single display.

The use of frames, however, is not typically suitable for non-kiosk public displays. Since public displays usually operate unattended, no user is available to make selections in one frame for corresponding content to appear in another frame. Further, a selection of a hyperlink in one frame can result in errors when, for example, the source for the hyperlink is unavailable. These so-called “broken links” result in unsightly or cryptic messages being displayed due to function-related problems, and also make the use of frames in public displays undesirable.

Public displays that show Internet-based content suffer from various drawbacks, particularly with regard to interruptions caused by available bandwidth, the reception of server-based content and internal or “local” errors. Internet content that becomes unavailable, for example, due to loss of an Internet connection or a remote server that is off-line, often results in errors being displayed. Such errors are increasingly likely when content is regularly and frequently updated.

### SUMMARY

The teachings herein address the above-identified shortcomings by providing a self-reloading public display system and method that provides an aesthetically pleasing and seamless display of content that changes over time. In case of an error, one or more messages are provided on a public display, such as in a residential building, to notify viewers in clear terms of an error, such as an interruption in Internet service, or a delay in the information feed to the public display. Further, self-correction steps are taken substantially automatically, and viewers are informed whether and when the situation will self-correct. Thus, seamless, smooth transitioning between messages is provided, as well as seamless indication of errors, or also as new information becomes available and ready for display.

In an embodiment, an outer frame is provided within a web browser operating within the display device, and at least two inner frames are contained in the outer frame. The outer frame may not be visible and each of the at least two inner frames is operable to alternate being visible and being not visible as a function of programming code executing within or by the outer frame, and each of the at least two inner frames is operable to display the content received from the computing device. In an embodiment, the computing device causes a first inner frame to visibly display content received over a communication network from an information processor, while a second inner frame remains not visible. An electronic request may be submitted by the computing device for new and/or updated content from the information processor. After the content is received, the second inner frame visibly displays the new and/or updated content and the first inner frame becomes not visible.

In an embodiment, the content includes information representing at least one event associated with at least one of a plurality of building units. Moreover, a determination may be made whether the new and/or updated content is successfully received from the information processor prior to causing the second inner frame from becoming visible and prior to causing the first inner frame from becoming not visible. In an alternative embodiment, the second frame is rendered visible after a short period of time, such as five seconds after a reload command is executed. In an embodiment, the determination is made as a function of code executing in the outer frame. Thereafter, (e.g., 25 seconds) a determination is made whether the new and/or updated content is successfully received and rendered. If not, then the second frame is rendered invisible, and another frame providing an error message is displayed and/or corrective measures are taken. Although this alternative embodiment may briefly display an error condition that may appear cryptic or unaesthetic, very current information is assured to be displayed, and one or more aesthetically pleasing messages are provided in short order.

Many other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement, for sending and receiving information over a communication network to be displayed to building occupants and visitors via a public display device, in accordance with an embodiment;

FIG. 2 is a block diagram illustrating the functional elements in an example information processor;

FIG. 3 is a block diagram illustrating HTTP frame elements of an example public display device, in accordance with an embodiment;

FIG. 4 illustrates an example management display device that is provided for an administrative user to view or change settings for a public display device, in accordance with an embodiment;

FIG. 5A illustrates an example setup display screen that is provided to an administrative user for selecting content to be displayed, in accordance with an embodiment;

FIG. 5B illustrates an example public display configuration display screen that is provided to an administrative user for customizing display options associated with a public display, in accordance with an embodiment;

FIG. 6A illustrates an example display screen that shows a grid of respective building unit numbers and corresponding events, in accordance with an embodiment;

FIG. 6B illustrates an example display screen that shows an error message associated with a data connection error, in accordance with an embodiment; and

FIG. 7 illustrates an example arrangement of respective buildings that are networked together via communication network, in accordance with an embodiment.

### DESCRIPTION OF EMBODIMENTS

In preferred embodiments, a web browser-based publicly accessible display device is provided that automatically receives content received over the Internet and that displays the content on the web browser application, and that overcomes the problems and shortcomings of the prior art, such as described above.

In an embodiment, a series of hypertext markup language (“HTML”) frames are provided in a web browser software application that operate to display Internet-based content smoothly and seamlessly. The present application manages an operating sequence that includes displaying Internet-based content in one frame, automatic loading data in a second frame while the second frame is hidden from view, and after a preset period of time or after the content is fully loaded, causing the first inner frame to become invisible and rendering the second inner frame visible. Thus, unlike prior art frames, which display content concurrently as content is received, the present application holds the display of data from view until the content is received and prepared for view, or until a predetermined period of time passes.

More particularly, the teachings herein provide a solution to shortcomings described above associated with prior art web browser software applications, particularly in connection with non-kiosk public displays, when a connection to a server or other source of content is interrupted or lost. In a preferred embodiment, an outer frame, which may be referred to in the art as a frame set, is provided in a web browser software application and is rendered hidden from view. A plurality of inner frames are provided within the outer frame. The outer frame is preferably configured with programming code that, when executed, controls the behavior and/or appearance of the inner frames. In this preferred embodiment, the outer frame does not regularly or frequently refresh or reload content from a data source, such as a web server. Instead, the outer frame remains active in local memory (e.g., random access memory or operates via a cache), and executes instructions to cause the inner frames to load and display information, among other things. Thus, even if a connection to a web site or other data source is dropped, the outer frame remains active because the outer frame is not configured to frequently reload or otherwise make calls or data requests to the web site or data source that would cause the outer frame to fail.

This provides a solution whereby the outer frame remains active, even in the event of a lost or dropped connection, and the outer frame manages the behavior and/or appearance of inner frames, including to schedule the inner frames to request and load data from a server or other data source. Although an inner frame may be unable to load data in the event of a dropped connection, for example, the outer frame remains unaffected by the dropped connection and still manages the behavior of that inner frame, including to preclude the inner frame from displaying an error message such as described above. As described in greater detail below and will become apparent to one skilled in the art, this provides a new solution to an old problem of using at least standard prior art web browser software to control the display of content prior to, during and after a connection to a data source is interrupted and/or later restored.

For example and in an embodiment, a web browser software application is provided that includes a hidden outer frame and at least two inner frames. A first inner frame is rendered visible by instructions executed by the outer frame and displays content from a web source. A second frame is rendered not visible by the outer frame, and receives an instruction from the outer frame to load or reload content from the same data source (e.g., web server). After a predetermined period of time or after the content is loaded in the second frame, the first frame is rendered not visible by the outer frame, and the second frame is rendered visible by the outer frame. Even if the content, per se, from the data source has not changed, the first and second frames alternately load the content and are alternately rendered hidden and displayed as a function of commands issued by the outer frame. In case the connection to the data source is interrupted or dropped, the outer frame still controls the behavior of the inner frame and preferably directs the respective inner frame that was previously populated with content to remain visible, thereby precluding the display of an error message in the other inner frame that is unable to load content from the data source due to the dropped connection. Moreover, when the content from the web source does change, the updated content is provided in a smooth, seamless way as the respective hidden inner frame that is provided with the changed content is rendered visible and the respective displayed inner frame with the obsolete content is rendered invisible.

In an embodiment, one or more of the inner frames is configured to issue an instruction to cause the outer frame to make a call to a data source, for example, to be provided with updated programming instructions or the like. In this embodiment, the outer frame receives an instruction to connect to the data source and download the content therefrom.

Thus, in accordance with an embodiment, frames are provided in unique ways that preclude the display of cryptic hypertext transport protocol (“HTTP”) error messages, such as described above. Errors are handled automatically, and informative messages are displayed in attractive ways. Further, frequently updated Internet-based content is displayed in a new, smooth, transition-free and aesthetically pleasing way. Accordingly, prior art shortcomings, such as described above and that are associated with public display of Internet content, including instances when an Internet connection or connection to a server is lost, are handled automatically and attractively.

In one embodiment, viewers of a public display device are notified when an interruption or other error has occurred after a predefined period of time, and/or that the system is attempting to resolve the error. In this embodiment, another inner frame, referred to herein as an “error-frame” is rendered visible that displays information representing the error. Moreover, one or more self-correcting instructions may be executed by the outer frame that attempt to re-establish the connection or otherwise handle an error. Once the error is resolved, the error frame is hidden and the frame in which the content has been loaded is rendered visible, thereby providing a visually smooth and seamless displayed transition.

Preferably, a building is provided with at least one publicly viewable display device that is operable for occupants, residents and/or tenants (collectively, “occupants”) to view building-related content. A plurality of public display devices may be provided in residential buildings, such as the buildings' foyers, elevators, laundry rooms, fitness areas or other areas of the residential buildings where occupants and visitors are likely to convene. Thus, the public display devices in accordance with the teachings herein display respective kinds of information for passersby in the vicinity of the public display device.

In an embodiment, the public display device that is provided in a residential building displays information in a grid for the occupants. For example, information representing package deliveries, occupant-related messages, maintenance information or the like is displayed in a grid for a plurality of building units. The data provided in the public display device may be transmitted over an HTTP connection from a server computing device, which may receive information from one or more other computing devices, such as that provide weather-related information, traffic conditions, news-related items or the like. New or updated content may be obtained via one or more instructions to reload content in a web browser application that are substantially automatically executed at the web browser, such as via a “client” application. For example, programming code may be provided, such as HTML, Java script or the like, to cause the web browser application to reload content substantially automatically.

As used herein, the term, “module,” refers, generally, to one or more discrete components that contribute to the effectiveness of the teachings herein. Modules can include software elements, including but not limited to functions, algorithms, classes and the like. Modules also include hardware elements, substantially as described below. Modules can operate independently or, alternatively, depend upon one or more other modules in order to function. Also as used herein, the terms “refresh” or “reload” refers, generally, to obtaining content for display from a server or other computing device. The content may be loaded for a first time, are may be reloaded.

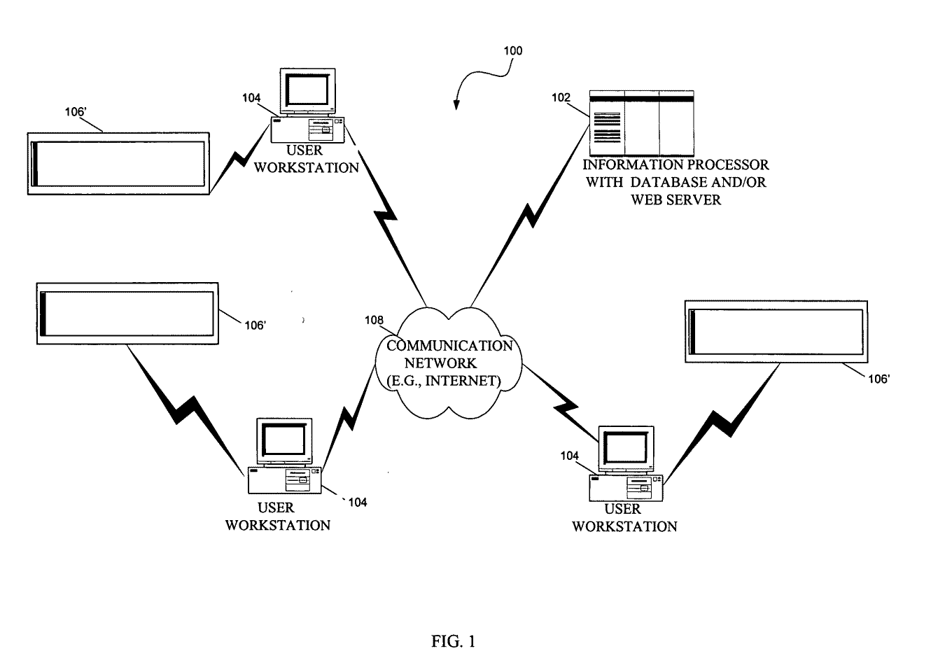

Referring now to the drawing figures, in which like reference numerals represent like elements, FIG. 1 illustrates an example hardware arrangement for sending and receiving information over a communication network to be displayed, for example, to building occupants and visitors via a public display device, in accordance with an embodiment, and referred herein, generally, as system 100. In the example shown in FIG. 1, system 100 includes information processor 102 operable to function as a web, data and file server, as known to those skilled in the art. Public display workstations 104 are operated by, for example, building administrative personnel and cause public display devices 106 to display content. Public display workstations 104 are operatively coupled to public display devices 106, and public display devices 106 display information via public display workstation 104. Public display devices 106 may be located in various places within in a building, or may be respectively located in public areas of different buildings or areas.

In an embodiment, public display device 106 is any device operable to display or output content. For example, public display device 106 may be formatted as a liquid crystal display (“LCD”) device, a plasma screen, a projector, a cathode ray tube (“CRT”) display, or other suitable type of equipment to display content.

Information processor 102 may store information regarding buildings, maintenance, vendors and occupants, as well as business-related information related to buildings and its occupants. Public display workstations 104 may be located in the buildings, but may be located remotely from displays 106. In an embodiment, information processor 102 receives data regarding public display workstations 104 that are located in the respective buildings, and information processor 102 may store the data received from public display workstations 104 in databases necessary to support the systems and methods provided herein. Alternatively or in addition, it is contemplated that information processor 102 can access any required database via communication network 108 or any other communication network to which information processor 102 may be coupled. Communication network 108 is preferably a global public communication network such as the Internet, but can also be a wide area network (WAN), local area network (LAN), or other network that enables two or more computers to communicate with each other.

In an embodiment, information processor 102 and public display workstation 104 are any devices that are capable of sending and receiving data across communication network 108, e.g., mainframe computers, mini computers, personal computers, laptop computers, a personal digital assistants (PDA), cellular telephones and Internet access devices such as Web TV. In addition, information processors 102 and public display workstations 104 are preferably equipped with web browser software, such as MICROSOFT INTERNET EXPLORER, MOZILLA FIREFOX, or the like. Information processors 102 and public display workstations 104 are coupled to communication network 108 using any known data communication networking technology.

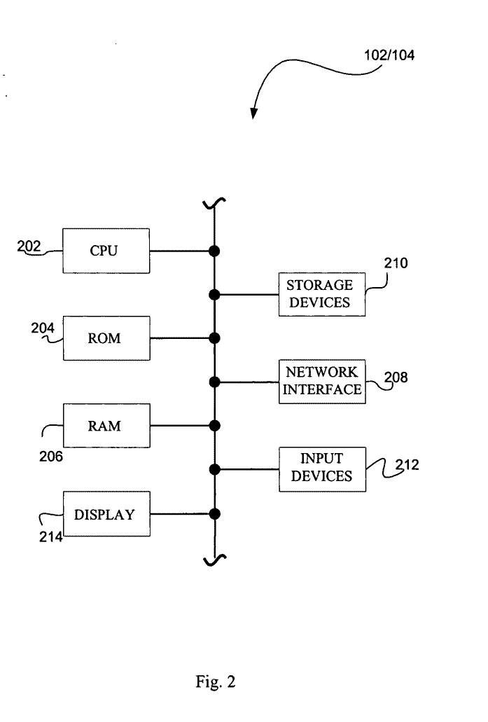

FIG. 2 illustrates the functional elements of an example information processor 102 and/or public display workstation 104, and includes one or more central processing units (CPU) 202 used to execute software code and control the operation of information processor 102. Other elements include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components of information processor 102 need not be physically contained within the same chassis or even located in a single location. For example, storage device 210 may be located at a site that is remote from the remaining elements of information processor 102, and may even be connected to CPU 202 across communication network 108 via network interface 208. Information processor 102 preferably includes a memory equipped with sufficient storage to provide the necessary databases, forums, and other community services as well as acting as a web server for communicating hypertext markup language (HTML), Java applets, Active-X control programs or the like to user workstations 104. Information processors 102 are arranged with components, for example, those shown in FIG. 2, suitable for the expected operating environment of information processor 102. The CPU(s) 202, network interface(s) 208 and memory and storage devices are selected to ensure that capacities are arranged to accommodate expected demand.

The functional elements of information processor 102 shown in FIG. 2 are of the same categories of functional elements present in public display workstations 104. However, not all elements need be present in the public display workstation 104. For example, storage devices, in the case of PDA's, and the capacities of the various elements are arranged to accommodate the expected user demand. For example, CPU 202 in public display workstation 104 may be a smaller capacity CPU than the CPU present in the information processor 102. Similarly, it is likely that the information processor 102 will include storage devices of a much higher capacity than storage devices present in public display workstation 104. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, .NET, AJAX, JAVA server pages, servlets, MYSQL, PHP and a plurality of web site development applications.

Although the systems and methods are described by way of example herein and in terms of a web-based system using web browsers and a web site server (e.g., information processor 102), system 100 is not limited to such a configuration. It is contemplated that system 100 is arranged such that public display workstation 104 communicates with and displays data received from information processor 102 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102 and public display workstation 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, MAC OS, UNIX, LINUX, PALM OS, POCKET PC and any other suitable operating system.

As used herein, references to displaying data on information processor 102 and public display workstation 104 regard the process of communicating data across communication network 108 and processing the data such that the data is viewed on a display 28, for example, by using a web browser and the like. Unlike typical web browsing software, however, public display device 106 preferably does not present sites within the system 100 such that a user can proceed from site to site within the system by selecting a desired link. Instead, information is provided substantially automatically and is self-reloaded, such that current content is viewable for passersby in the viewing range of public display device 106.

Public display device 106 preferably displays information as a function of programming commands that are executed substantially automatically and not in response to user commands. In accordance with the teachings herein, programming statements (i.e., software) are executed on public display workstation 104 that cause an HTTP frame set to be manipulated, such that inner frames are provided with and/or display content from a frame source (i.e., a source of information). The programming statements enable one or more inner frames to receive updated content, thereby ensuring that content displayed on public display device 106 is current.

In an embodiment, the frequency by which updated content is retrieved (e.g., how often updated content is retrieved) from a server, such as information processor 102 is performed as a function of client side programming code that executes without user-supplied interaction via an outer frame. Client side programming code operates on public display workstation 104 that, when executed, causes an outer frame (or frame set) to control the frequency at which content is retrieved from information processor 102, and/or to control the way that content is displayed. For example, programming statements executed by the outer frame cause one or more inner frames in a web browser on workstation 104 to check for content every one minute (or other time period), indefinitely. In an alternative embodiment, content is not provided to workstation 104 until new or updated content on information processor 102 is available, thereby reducing bandwidth requirements associated with frequent and/or regular data requests for updated from content from information processor 102.

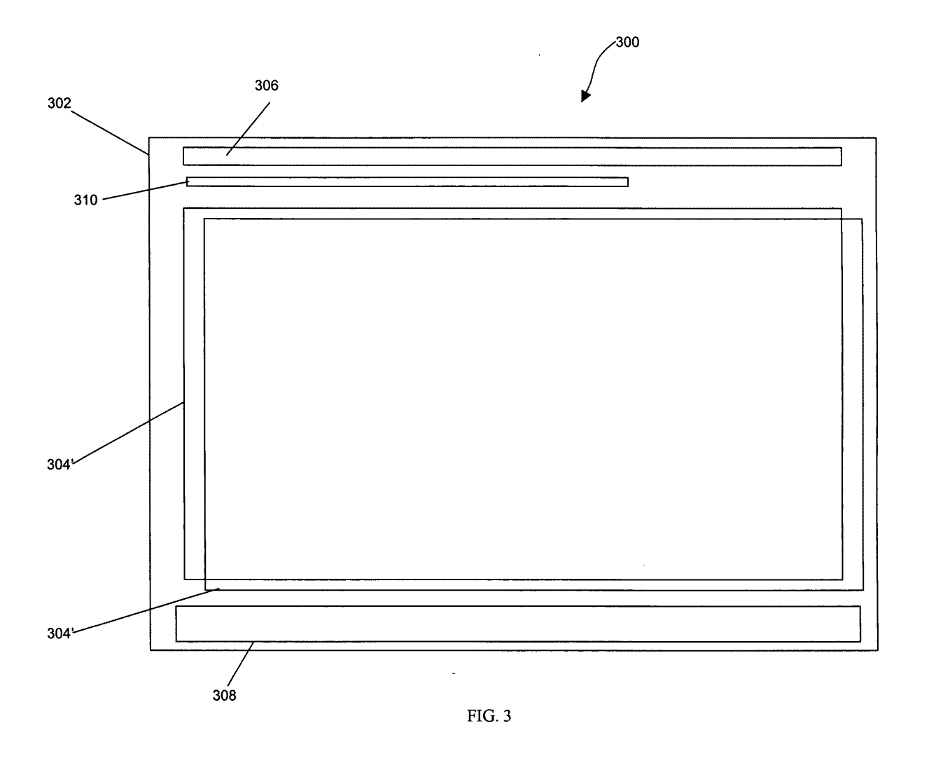

FIG. 3 is a block diagram illustrating HTTP frame elements 300 of public display device 106, in accordance with an embodiment. As shown in FIG. 3, outer frame 302 is provided as the frame set for which a plurality of inner frames 304′ are placed. Programming code is provided in various ways and, in at least one embodiment, to control the appearance of inner frames 304′, as well as to define and/or control a content source for respective frames.

As noted above, outer frame 302 is preferably not displayed and remains active in RAM on workstation 104 as long as the web browser software application remains open. As noted above and in a preferred embodiment, outer frame 302 does not directly request data or content from a data source, such as a web server, and the loss or interruption of internet service or an interrupted data communication session does not preclude the outer frame from functioning normally. Preferably, programming code in the form of client-side programming code is provided in outer frame 302 or otherwise provided such that instructions executed by outer frame 302 via the client-side programming code control the behavior and appearance of respective inner frames 304′, substantially as described herein. For example, inner frames 304′ alternately load content from a server and respectively alternate being hidden and displayed, as a function of commands issued or invoked by outer frame 302. If an Internet connection is down and an inner frame 304′ cannot communicate with a data source, outer frame 302 controls the appearance of inner frame 304′, such as to render inner frame 304′ hidden from view.

In an embodiment, outer frame 302 causes inner frames 304′ to display information graphically for building occupants in a frequently updated grid. In addition to frames 304′, other frames (e.g., inner frames 306, 308) may be provided that display information that may be in response to commands received via outer frame 302. Examples include information representing when the grid was last updated with information, information representing the name of a building where public display 106 is located, and information representing current date, time and weather conditions. As noted above, weather information or other on-line content may be obtained from one or more third-party computing devices and transmitted over communication network 108 to information processor 102, and transmitted to workstation 104 to be displayed on public display device 106. Inner frame 308 may display information for occupants, such as to notify occupants of an interruption in displaying up-to-date information. Typically, inner frames 306 and 308 do not require new and/or updated information from information processor 102 as frequently as inner frames 304′. Accordingly, inner frames 306, 308 may not provide a mechanism, referred generally to herein as a “heartbeat” and described in more detail below, that is to represent that a successful transmission of data from information processor 102 has been received.

As noted above, two or more inner frames 304′ provided in frame set 302 are controlled such that only one of the inner frames 304′ may be displayed at a time. The respective frame 304′ that is displayed includes the most recently updated content received from information processor 102. The second inner frame 304′ is not displayed until updated and/or new content or information has been successfully retrieved from information processor 102 and when no errors were encountered. Thus, the second inner frame 304′ remains hidden. After the hidden inner frame 304′ is populated with the new and/or updated content from information processor 102, the first inner frame 304′ is instructed to become hidden, and the populated inner frame 304′ is instructed to be displayed, substantially simultaneously, thereby avoiding an undesirable “painting” effect or a temporary blank screen. After a predefined period of time, such as one minute, outer frame 302 instructs the hidden inner frame 304′ to make a new request for content to information processor 102, and the updated content is received by and loaded into the first (hidden) inner frame 304′. In one embodiment, once the outer frame 302 determines that the first inner frame 304′ is properly populated with information, outer frame 302 instructs the second inner frame 304′ to become hidden and instructs the first inner frame 304′ to be rendered displayed. In other words, the first and second inner frames 304′ alternate being hidden and displayed with content, even though the content may or may not be different. In this way, content is displayed in a smooth, seamless and uninterrupted way, with an assurance that errors, such as related to Internet connectivity or server computer availability, are displayed in a controlled, meaningful and aesthetic way. Moreover, public display workstation 104 may execute one or more self-recovery steps to preclude a need for an individual from having to manually operate public display device 106 and/or workstation 104.

In an alternative embodiment, after an estimated, predetermined amount of time for the content to be received from information processor 102, the hidden inner frame 304′ is populated with content and rendered visible without a determination by outer frame 302 that all content have been received and/or that no errors were encountered. After a second predetermined amount of time and after the hidden frame 304′ is rendered visible, outer frame 302 determines whether the content was completely received. If not, then outer frame 302 instructs the inner frame 304′ to be rendered invisible, and issues other instructions for other action to be taken, such as to display an error message or display the previously populated hidden frame 304′.

In an embodiment, a mechanism, generally termed a heartbeat, is provided for confirming that content has been successfully retrieved from information processor 102 and/or that no errors were encountered that would otherwise interfere with accurate, updated and an aesthetically pleasing display of information. In this embodiment, one or more instructions are executed, for example, via programming code executing within or as a function of outer frame 302 to examine a data value that is provided within at least one of the inner frames 304′ to determine whether updated and/or new information has been successfully obtained from information processor 102. Thus, the data value represents that all of the data requested from information processor 102 has been obtained. In one embodiment, information processor 102 transmits the data value to workstation 104. If outer frame 302 cannot identify the data value, then an assumption is made that an connection interruption or other event occurred that precluded the data value, and, accordingly, all of the new and/or updated information, from being obtained. In this case, outer frame 302 does not issue an instruction to render the hidden inner frame 304′ visible, or otherwise affirmatively instructs the hidden inner frame 304′ to remain hidden, while the displayed inner frame 304′ remains visible. This process ensures that public display device 106 consistently displays content that is current and complete.

In an alternative embodiment, a content source provided for the inner frame 304′, including the data value, is disconnected just prior to or after the frame is rendered not visible. Thereafter, public display workstation 104 determines prior to rendering the hidden inner frame 304′ visible whether content, including the data value, has been successfully provided therein.

One skilled in the art will recognize that the “heartbeat” data value can be formatted in various ways, such as a simple one-byte numeric value. If the data value exists (e.g., it is positive), then a determination can be made that all of the data were successfully obtained from information processor 102 and the populated hidden inner frame 304′ can be switched from being hidden to visible. Otherwise, if the data value does not exist (e.g., it is negative), then the opposite conclusion can be reached. In another embodiment, the data value remains stored in inner frame(s) 304′, but the value changes from one value (e.g., 1) to another value (e.g., 2) and then to a different value or back to the first value (e.g., 1) each time public display workstation 104 successfully and completely retrieves data from information processor 102. Public display workstation 104 may store, for example, a current data value in a temporary memory, and is able to determine when the value changes. The new value is, thereafter, stored in the memory until the value changes again, such as following the next successful reception of content from information processor 102. Accordingly, the data value acts as a form of a heartbeat for outer frame 302 to assess whether a problem has occurred and that the hidden inner frame 304′ is not ready to be made visible.

Additionally, a time period, such as 30 seconds after outer frame 302 instructs an inner frame 304′ to make a request to information processor 102 for new and/or updated information, is defined that represents a delay before examining the data value to determine whether the transfer of data from information processor 102 was completed successfully. For example, a command is issued from outer frame 302 that requests information processor 102 to transmit data to public display workstation 104. Thereafter, outer frame 302 may wait the predetermined time period (e.g., 30 seconds) before checking the data value to ensure that all data have been successfully transmitted from information processor 102.

In accordance with an embodiment, a mechanism is provided that displays an informative and aesthetically pleasing message in case of an error, such as an Internet connection interruption. Continuing with reference to FIG. 3, an additional inner frame 310 may be provided in frame elements 300 for error handling and/or to display a message that an error or other event has occurred that prevented new and/or updated information from being displayed and/or received from information processor 102. In the event of an error, outer frame 302 may issue one or more instructions to cause inner frame 310 to be displayed, and the previously displayed content-based inner frame 304′ gets hidden. The error-handling frame 310 may include a message to inform viewers of a predetermined time in which an attempt to reestablish a connection will be made. In this way, occupants do not view stale, cryptic or unsightly error messages, and are made aware that a correction to the error is being sought.

Thus and as shown in the block diagram FIG. 3, a plurality of inner frames is provided in frame set 302. The inner frames may be monitored and modified in connection with one or more data-related events that may occur in connection with transmissions between information processor 102, public display workstation 104 and/or various other selected information processor(s). The frames may also display information from public display workstation 104 that relates to a particular event, condition and/or service for a respective building.

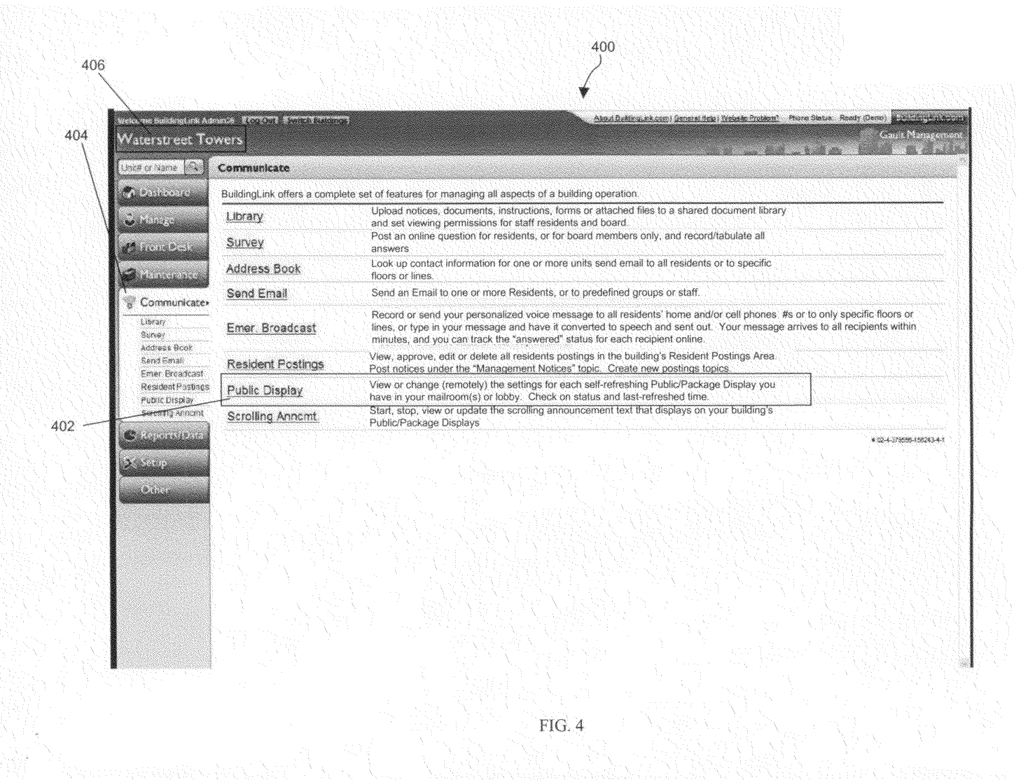

In order for content to be selected and displayed on public display device 106, public display workstation 104 may include a graphical user interface (“GUI”) that enables an administrative user to define, select, review and/or monitor display settings, content, status information or the like. FIG. 4 illustrates an example management display screen 400 that is provided for an administrative user to view or change settings for public display device(s) 106, as well as to check the status and/or the last time data were transmitted to a respective public display device 106. In the example display screen 400 shown in FIG. 4, the user selects the communicate tab 404 for the option for public display. Also shown in FIG. 4, a respective building name, “Waterstreet Towers,” is displayed in building name display 406. Accordingly, information regarding public display devices 106 is available for respective buildings. Moreover in an embodiment, remote access is preferably available for users to access the GUI at a location that is remote from a respective building, e.g., Waterstreet Towers. In one embodiment, public display workstation 104 is functional as an HTTP or other accessible server, thereby enabling users to remotely access display screen 400 over, for example, a secured connection using standard web browsing software.

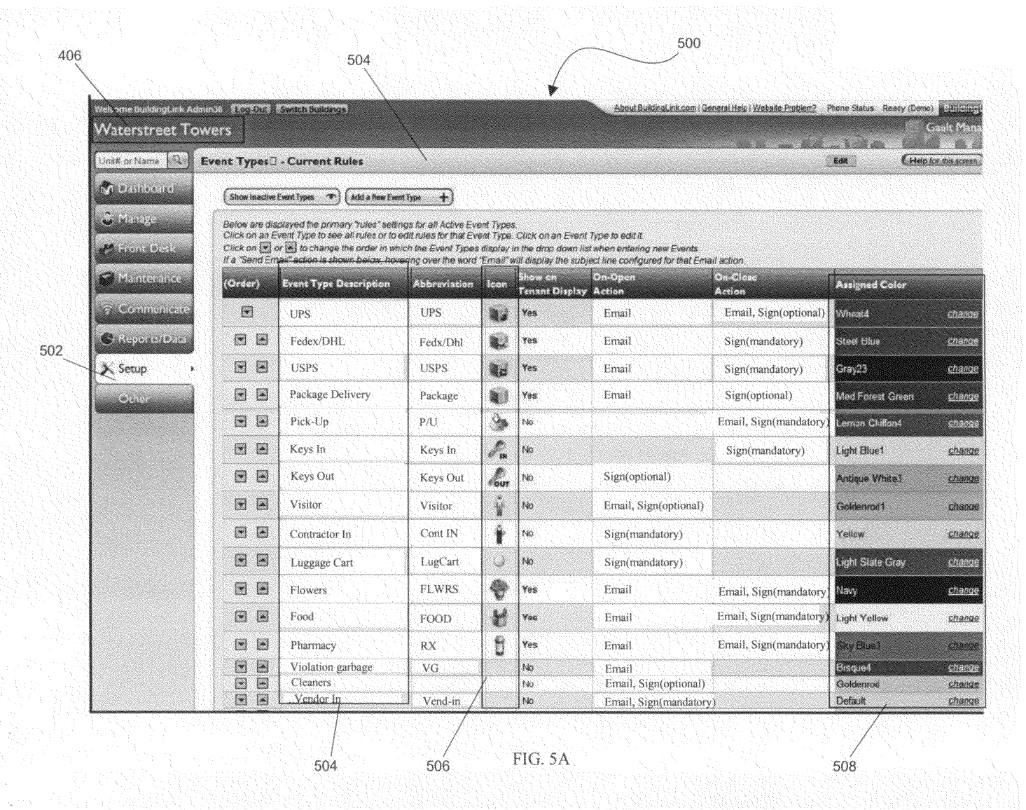

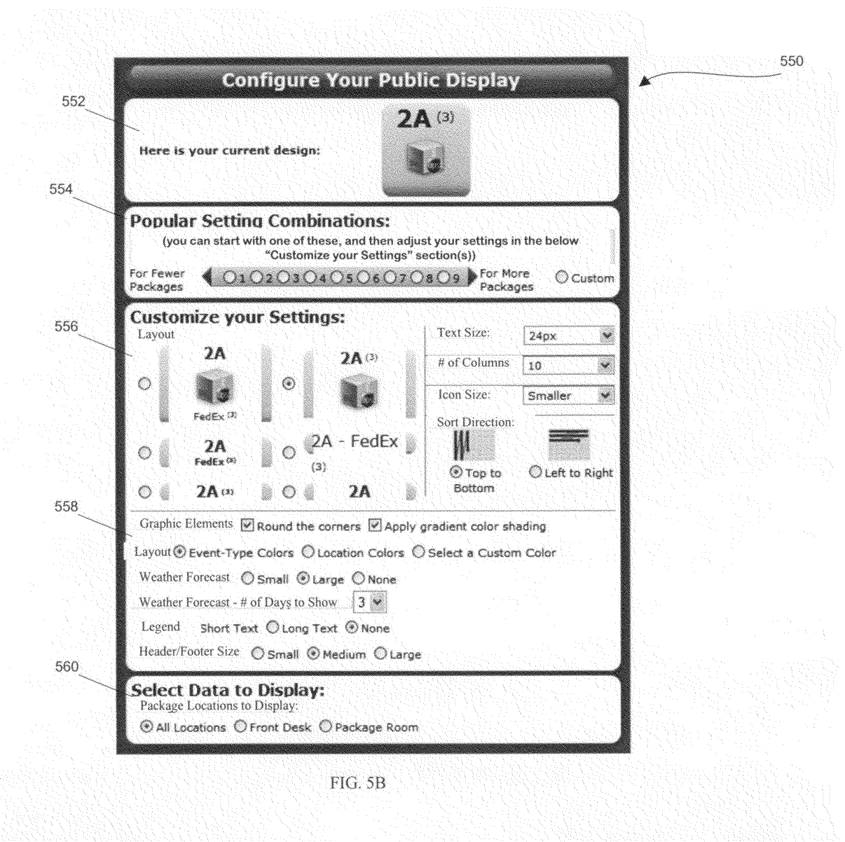

FIG. 5A illustrates an example setup display screen 500 that is provided to an administrative user who selects setup tab 502. As shown in the example in FIG. 5A, current rules section 504 is displayed for setting primary rules for active event types. Section 504 provides controls for users to add new events, and/or modify or delete existing rules and/or events. In an embodiment, users select an event type to review rules and/or to edit an event type. Event descriptions 504 and corresponding icons 506 are provided for a user to provide descriptive text for various events. In the example shown in FIG. 5A, event descriptions are defined for UNITED PARCEL SERVICE (“UPS”) and FEDEX/DHL deliveries, as well as for generic package delivery, item pick-ups, key tracking (in and out), visitor tracking (in and out), contractor tracking (in and out), luggage cart, flower delivery, food delivery, medication delivery, delivery from cleaners, or the like. Moreover, corresponding icons 506 and color codes 508 are defined for each respective event. Other information, such as description abbreviations, an indicator whether an event is to be displayed on public display 106, and actions to be defined upon occurrence of the event may also be defined via controls provided in display screen 500. Accordingly, once events are defined, occupants of a building can determine at a glance of public display device 106 information for particular units in the building.

FIG. 5B illustrates an example public display configuration display screen 550 that includes controls for customizing display options associated with public display 106. As shown in example display screen 550, current design preview 552 provides a preview of a grid cell that will appear in a grid display on public display 106. Popular setting combinations section 554 provides options representing “popular setting combinations” for a plurality of default settings that correspond to a number of packages. Depending upon the number of packages selected, a particular text size, icon selection and size, number of columns for a grid, building unit sort direction, and other graphical selections are made for the user. In an embodiment, after a popular setting combination is made, the user is provided with the ability to customize the options by making individual selections, such as to the options listed above.

Continuing with reference to FIG. 5B, “customize your settings” option 556 provides controls for selecting various display options. In the example shown in FIG. 5B, layout choices are available for the appearance of an icon, including the layout of information that adjacent to the icon, text size of text adjacent to an icon, the number of columns in a grid, an icon size, and the sort of direction of grid cells representing building units in the grid. Public display screen options section 558 include choices for selecting how graphic elements are presented (e.g., rounded corners and gradient color shading), color schemes (e.g., event-type colors, location colors, and/or custom colors), size appearance for weather-related information (e.g., to be displayed in inner frame 306) (FIG. 3), appearance of a legend (e.g., short text, long text or none), and sizes for a header/footer (e.g., (e.g., small, medium or large). Moreover, public display configuration display screen 550 includes select data to display section 560, which provides options for a user to select particular package locations to display, including all locations, a front desk or a package room. In other words, the display of a location of a package to be picked up is selected by a user in section 560.

Thus, and as shown in the embodiment of FIG. 5B, options are provided for defining the appearance of a grid, including associated icons, textual appearances, and content. Although the example shown in FIG. 5B is associated with packages, one skilled in the art will recognize that various other kinds of information are applicable for public display configuration display screen 550 that are related to notifying occupants of many types of information.

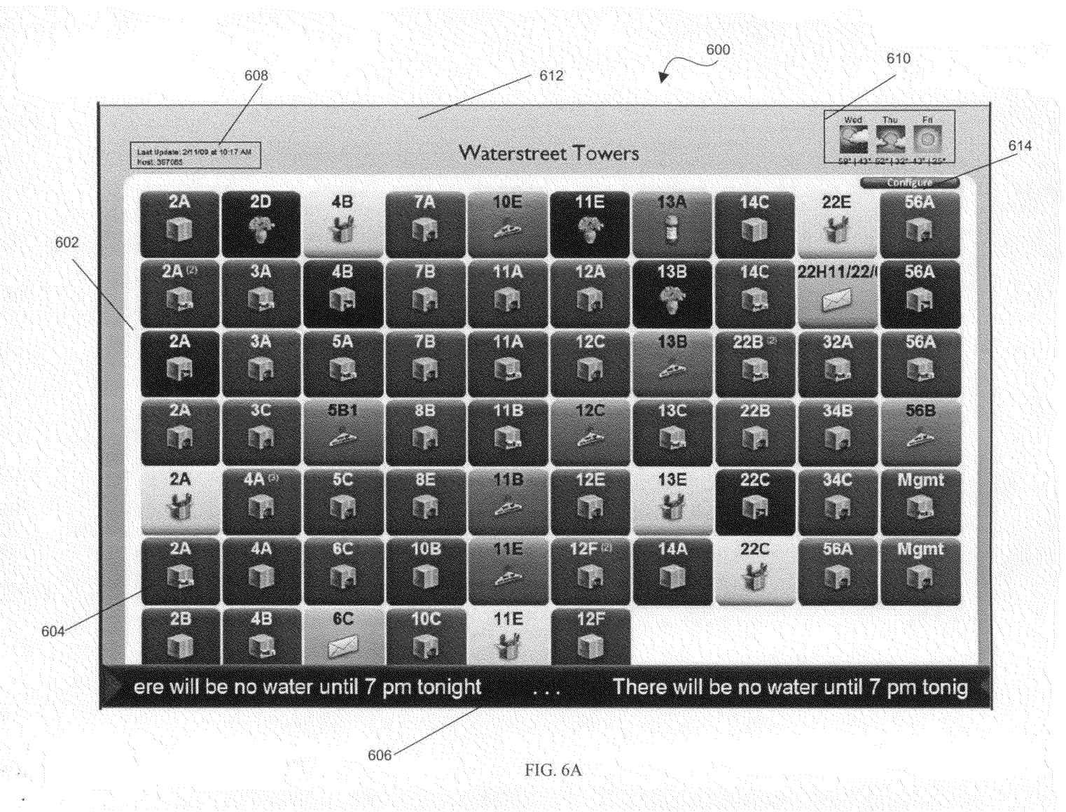

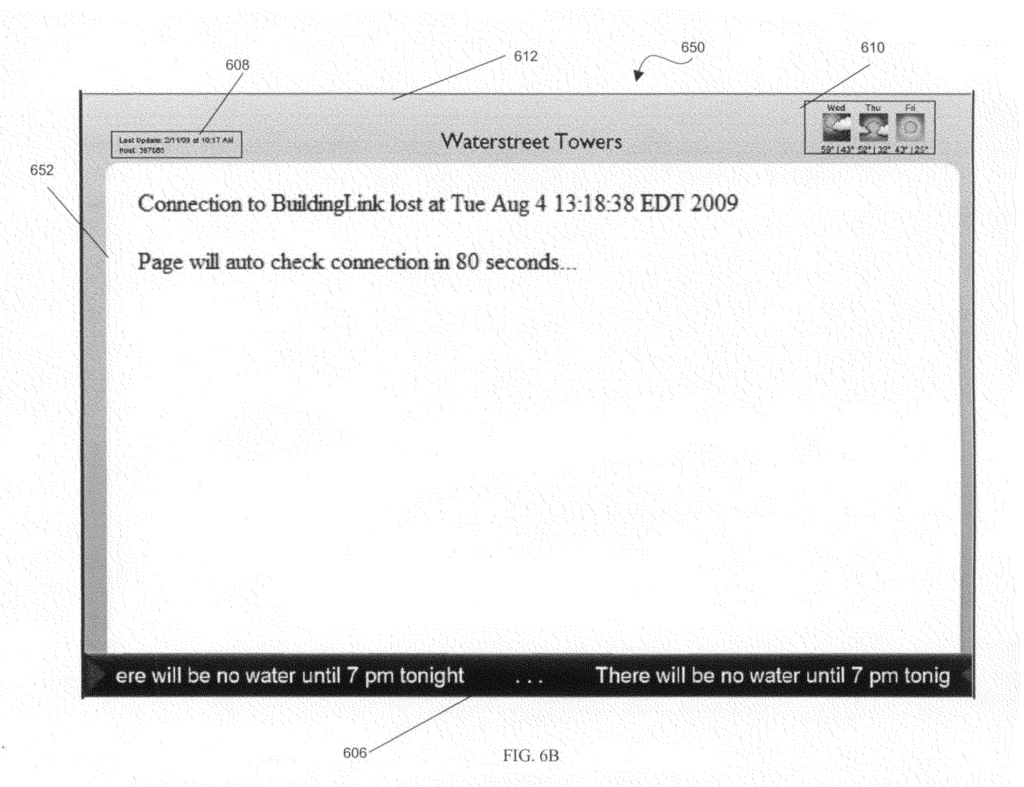

FIG. 6 illustrates an example display screen 600 that shows an example grid 602 illustrating a plurality of grid cells 604 for respective building units and corresponding events related thereto. In the example display screen 600, each grid cell 604 identifies a building unit number, is color coded and includes icons previously defined in setup display screen 500 (FIG. 5A) that represent particular events. In the example shown in FIG. 6, building unit 2A is identified as having one package delivery, two FEDEX deliveries, one U.S. Postal Service delivery, one UPS package delivery and one food delivery. Unit 2B is illustrated as having a package delivery. In accordance with an embodiment, grid 602 is provided within inner frames 304′. When new or updated information is obtained from information processor 102, grid 602 is preferably provided within a hidden inner frame 304′. After a successful transmission of information from information processor 102 is confirmed, or after a predetermined period of time (e.g., between 5 and 10 seconds), the displayed inner frame 304′ is hidden, and the hidden inner frame 304′ containing grid 602 that is populated with the new and/or updated information is displayed. In this way, a smooth, seamless and informative graphical display of current and updated data can be provided for many people to review, at just a glance.

In addition to grid 602, display screen 600 includes other elements, via additional inner frames. In the example shown, message section 606 provides a scrolling textual display of information. In the example shown in FIG. 6, message section 606 indicates that there will be no water available until 7:00 p.m. Text for message section 606 is particularly useful to provide short, important notifications that can be regularly updated or revised, as situations or conditions change.

Continuing with reference to FIG. 6, last updated section 608 identifies the most recent date and time when grid 602 was updated with content from information processor 102. Moreover, last updated section 608 includes an identifier of a host (e.g., public display workstation 104) to which public display device 106 is operatively coupled. Additionally weather section 610 graphically displays weather information. As noted above, content to be displayed in weather section 610 may be received from a third-party server computer, such as provided by the National Weather Service. Last updated section 608 and weather section 610 are shown in header portion 612, which includes the name of the building where public display device 106 is located, in this example, “Waterstreet Towers.”

FIG. 6B illustrates an example display screen that 650 shows an error message associated with a data connection error, in accordance with an embodiment. The example display 650 shown in FIG. 6B is the same example as illustrated in FIG. 6A, except that the data connection to information processor 102 has been severed. Message section 652 notifies passersby that a connection to information processor 102 (illustrated by the computer name “BuildingLink”) is lost. In the example shown, the time and date of the connection loss is also displayed, and a message is displayed indicating the amount of time in which an attempt to restore the connection will be made. In example display screen 650, the message indicates that the page will auto check the connection in 80 seconds. In this way, passersby are not left wondering why data is not being displayed and whether any steps are or will be taken to resolve the matter.

In the example display screen that 650 shown in FIG. 5B, the previously populated and displayed inner frame 304′ is hidden, and an error frame showing message section 652 is displayed. An efficient and aesthetically pleasing way of handling errors is shown, such as related to Internet connectivity. Of course, one skilled in the art will recognize that the example message section 652 is one of many examples of formatting messages, and that other message formats, including textual and/or graphical formats, are envisioned herein.

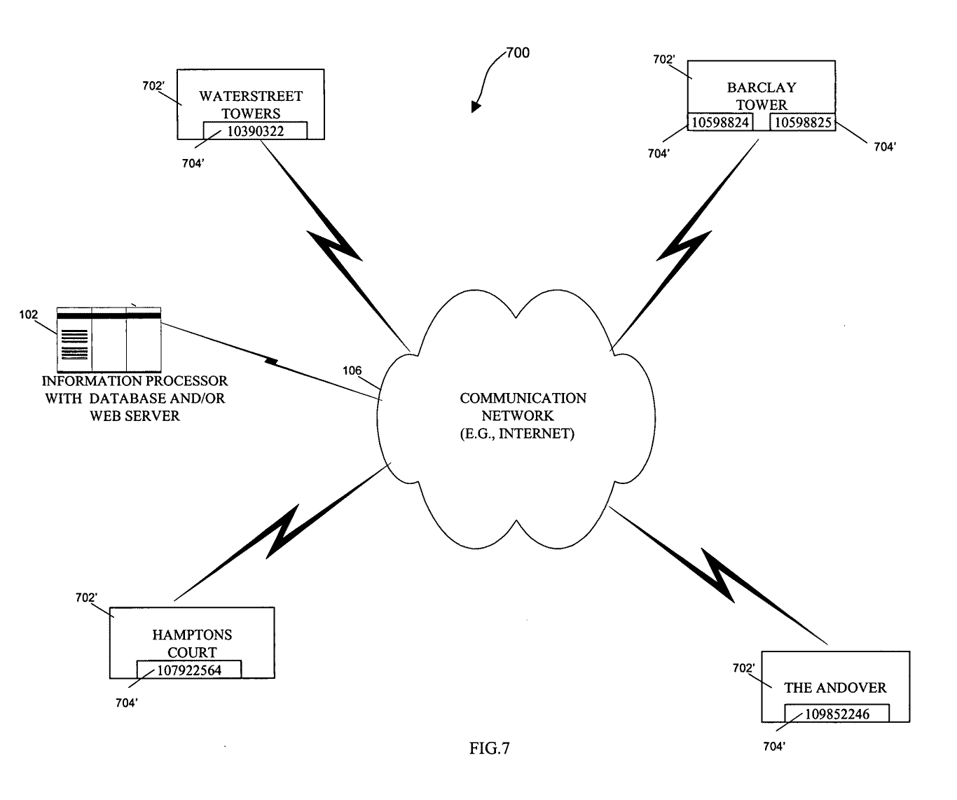

Public display devices 106 may be provided in a plurality of respective buildings. FIG. 7 illustrates an example arrangement 700 of buildings that are networked together via communication network 106 and operable to receive information from information processor 102. In the example shown in FIG. 7, four example buildings 702′ are shown: Waterstreet Towers, Barclay Tower, Hampton Court and The Andover. Each of the buildings 702′ is preferably provided with one or more unique identifiers 704′ that identify each of the public display workstations 104 within the respective buildings 702. Each of the workstations 104 is provided with a unique identifier 704′ that allows information processor 102 to transmit respective information or settings thereto. In case of two displays, such as located in an East Mailroom and a West Mailroom, each display can be individually configured to display respective content, notwithstanding that the displays are located in the same building. Moreover, information processor 102 can preferably access information regarding a building's 702′ respective public display 106 as a function of the workstation 104 represented by identifier 704′. Accordingly, the identifiers 704′ enable information processor 102 to direct responses to requests for information to the correct user public display device 106 for workstation 104 associated with building 702′.

In a preferred embodiment, identifiers 704′ are also used by each respective building's public display workstation 104 to provide automatic authentication with information processor 102. For example, a public display workstation 104 submits to information processor 102 authenticating information, such as an operator's user name and password, to provide secured access to information processor 102. Moreover, identifier 704′ may be submitted to enable information processor 102 to identify a respective public display device 106 in building 702′. The authentication information may be stored in a suitable data file, for example, a “cookie” as known in the art, and used for future automatic authentication of public display workstation 104 to information processor 102.

Public display device 106 is often operable without a human user controlling public display workstation 104. Automatic procedures execute on public display workstation 104 to cause public display device 106 to display new and/or updated information, without the need for human intervention. Occasionally and as known in the art, an interruption or other event may occur that causes public display workstation 104 to lose power or otherwise to lose its connection to information processor 102. In such an event, public display workstation 104 may be programmed to automatically connect to and authenticate itself to information processor 102, partly as a function of the data file or “cookie.” By providing an automatic authentication to information processor 102 during or shortly after, for example, an initial boot-up sequence, a human operator need not be present to operate public display workstation 104 and reestablish an authenticated connection to information processor 102. Instead, a self-correcting and self-authenticating process are provided with public display workstation 104.

In an embodiment, each time a request for updated and/or new information is transmitted from public display workstation 104 to information processor 102, the respective identifier 704′ is included in the request. Information processor 102 preferably uses identifier 704′ to transmit updated and/or new information to the respective public display workstation 104 (and public display device 106) associated with identifier 704′. Information processor 102 may store and maintain information regarding each of the plurality of identifiers 704′, and retrieves current information from its database(s) that is associated with identifier 704′. Moreover, the information transmitted to the public display workstation 104 may correspond with the respective identifier 704′ contained in the request.

Management functionality may be provided with information processor 102 to assess the status of each of a plurality of public display devices 106, as well as to receive information from public display workstation 104. Thus, a dynamic relationship between management functionality is provided on public display workstation 104 and information processor 102 that maximizes efficient control and display of information on a plurality of respective public display devices 106.

Unlike prior art displays, which display many graphics in a sequential fashion (i.e., top first, then bottom) until the content is fully loaded, a smooth and “flicker free” display is provided. A system and method for “switching” functionality is provided that results in an apparent instantaneous fashion, as frames containing Internet-based content are completely preloaded prior to being displayed, in an embodiment. Also and in accordance with an embodiment, instructions are executed that calculate and provide for complex timing of operations, such as a desired interval of time that should elapse before an outer frame issues a new command to reload and/or to display an inner frame. Other timed operations may include a desired delay period of time, such as 20 seconds, for the outer frame to wait following a reload command and prior to evaluating whether an inner frame is fully provided with data. Still other timing operations may include determining whether to hide a visible inner frame and, in its stead, enable the display of a currently hidden inner frame, to display an error screen, or to hide a currently displayed error screen, in case a previously failed reload of an inner frame is now resolved and fully populated with data. Each of these and other considerations provided in accordance with the teachings herein operate to provide an accurate, smooth, continuous and seamless display of information.

In accordance with the teachings herein, the ability to recover from a loss of Internet service or other connection without intervention is provided in a seamless way and without an appearance of interruption. Moreover, aesthetic and useful information is provided to users in the event of Internet service loss, preferably until a recovery of service is achieved. Furthermore, a system and method is provided for seamless switching between screens of changing content

Although the present invention is described and shown in relation to particular embodiments thereof, many other variations and modifications and other uses will become apparent to those skilled in the art. Occasionally, for example, outer frame 302 may need to be updated or reloaded with new code, such as a program patch, for various kinds of functionality. Accordingly, programming code may be provided in one or more inner frames that, when executed, causes the outer frame to reload. Alternatively, a server such as information processor 102 sends a reload command that, when executed, causes updated programming code to be installed for the outer frame.

In another embodiment, a setting, such as a value representing a current version can be transmitted as part of the inner frame contents. The version is incremented whenever the updated content or instructions for the outer frame is received, which is then compared by the inner frame to the version value loaded into the then-current outer frame. If the values are not equal, then the inner frame issues a reload command to the outer frame, causing the updated content and the updated version value to be loaded in the outer frame. In this way, content for the outer frame can be changed by the server as often as desired without a need for the server to determine (e.g., to keep track of) whether a particular outer frame has already loaded that content or needs a reload command.

Thus, various embodiments and variations are shown and described herein, and it is preferred, therefore, that the present invention be limited not by the specific disclosure herein.

What is claimed is:

1. A self-refreshing display system, comprising:
a computing device comprising at least one processor, processor readable media, and a communication device;
a display device operatively coupled to the computing device, wherein the display device displays content from the computing device; and
an outer frame provided in the display device, and at least two inner frames contained in the outer frame, wherein the outer frame is not visible and each of the at least two inner frames alternate being visible and being not visible, and further wherein each of the at least two inner frames displays the content received from the computing device,
wherein the at least one processor is programmed and configured to execute a first of at least one instruction from the outer frame to cause a first of the at least two inner frames to visibly display first content received over a communication network from an information processor via the communication device while a second of the at least two inner frames is not visible;
wherein the at least one processor is further programmed and configured to execute a second of at least one instruction from the outer frame to cause a second of the at least two inner frames to transmit an electronic request via the communication device for second content from the information processor,
wherein the communication device receives from the information processor in response to the electronic request the second content and further wherein the at least one processor is further programmed and configured to execute a third of at least one instruction from the outer frame to cause the second of the at least two inner frames to visibly display the second content and to cause the first of the at least two inner frames to become not visible.

2. The self-refreshing display system of claim 1, wherein the first and second content represent at least one event associated with at least one of a plurality of units in a building.

3. The self-refreshing display system of claim 1, wherein the at least one processor is further programmed and configured to execute a fourth of at least one instruction from the outer frame to determine whether the second content is successfully received from the information processor prior to causing the second of the at least two inner frames to become visible, prior to causing the first of the at least two inner frames from becoming not visible.

4. The self-refreshing display system of claim 1, further comprising a timer provided in the outer frame that is used by the at least one processor to send the electronic request after a predefined period of time.

5. The self-refreshing display system of claim 1, wherein the information processor identifies the computing device by an identifying code.

6. The self-refreshing display system of claim 5, wherein the computing device establishes an authenticated connection with the information processor as a function of the identifying code.

7. The self-refreshing display system of claim 6, wherein the authenticated connection occurs substantially automatically during a boot-up process of the computing device.

8. The self-refreshing display system of claim 1, further comprising a third inner frame that is contained in the outer frame and that alternates being visible and not being visible, wherein the at least one processor is further programmed and configured to execute a fifth of at least one instruction from the outer frame to cause the third inner frame to visibly display third content after the second content is not successfully received from the information processor and to be not visible after the second content is successfully received from the information processor.

9. The self-refreshing display system of claim 1, wherein the at least one processor is further programmed and configured to execute a sixth of at least one instruction from the outer frame to cause the first of the at least two inner frames to transmit a second electronic request to the information processor for the second content.

10. The self-refreshing display system of claim 1, further comprising a fourth inner frame that is contained in the outer frame and that alternates being visible and not being visible, wherein the at least one processor is further programmed and configured to execute a seventh of at least one instruction from the outer frame to cause the fourth inner frame to visibly display fourth content representing at least one event associated with a plurality of building units.

11. A method for displaying information representing a plurality of units in a building, the method comprising:
providing an information processor that is in operable communication with a public display workstation over a communication network;
storing in an electronic database information representing at least one event associated with at least one of the plurality of units in the building;
accessing, by the information processor, the electronic database to retrieve the information representing the at least one event;
generating, by the information processor, first electronic instructions operable for a public display workstation to graphically display the at least one event associated with the at least one of the plurality of units in the building; and
transmitting, by the information processor, the first electronic instructions to the public display workstation, wherein the public display workstation uses the electronic instructions to display the graphic representation of the at least one event on a public display device.

12. The method for displaying information of claim 11, wherein the at least one event is a delivery for at least one of the plurality of units in the building.

13. The method for displaying information of claim 11, further comprising:
defining, by the public display workstation, an outer frame in the public display device, and at least two inner frames contained in the outer frame, wherein the outer frame and the at least two inner frames are provided in a web browser software application;
causing, by the public display workstation, the outer frame to be not visible and each of the at least two inner frames to alternate being visible and being not visible;
causing, by the public display workstation in response to instructions in the outer frame, a first of the at least two inner frames to graphically display the at least one event associated with the at least one of the plurality of building units; and
causing, by the public display workstation in response to the instructions in the outer frame, a second of the at least two inner frames to be not visible.

14. The method for displaying information of claim 13, further comprising:
storing in the electronic database second information representing at least one other event associated with the at least one of the plurality of units in the building;
accessing, by the information processor, the electronic database to retrieve the second information representing the at least one other event;
generating, by the information processor second electronic instructions operable for the public display workstation to graphically display the at least one other event associated with the at least one of the plurality of units in the building; and
transmitting the second electronic instructions to the outer frame on the public display workstation, wherein the public display workstation uses the second electronic instructions to cause:
the second of the at least two inner frames to graphically display the at least one other event associated with the at least one of the plurality of units in the building; and
causing, by the public display workstation, the first of the at least two inner frames to be not visible.

15. The method for displaying information of claim 13, further comprising:
defining, by the public display workstation in response to the instructions in the outer frame, a third inner frame that is contained in the outer frame;
causing, by the public display workstation in response to the instructions in the outer frame, the third inner frame to alternate being visible and not being visible; and
causing, by the public display workstation in response to the instructions in the outer frame, the third inner frame to visibly display a message in case the first of the at least two inner frames cannot graphically display the at least one event associated with the at least one of the plurality of units in the building.

16. The method for displaying information of claim 11, further comprising transmitting, by the public display workstation in response to the instructions in the outer frame, a second electronic request to the information processor for the second content.

17. The method for displaying information of claim 11, further comprising defining, by the public display workstation in response to the instructions in the outer frame, a fourth inner frame that is contained in the outer frame;
causing, by the public display workstation in response to the instructions in the outer frame, the fourth inner frame to alternate being visible and not being visible; and
causing, by the public display workstation in response to the instructions in the outer frame, the fourth inner frame to visibly display a message representing at least one event associated with the plurality of units in the building.

18. The method for displaying information of claim 11, wherein the information processor identifies the public display workstation by an identifying code.

19. The method for displaying information of claim 18, further comprising establishing, by the public display workstation in response to the instructions in the outer frame, an authenticated connection with the information processor as a function of the identifying code.

20. The method for displaying information of claim 19, wherein the authenticated connection occurs substantially automatically during a boot-up process of the computing device.

21. A display system, comprising:
a first computing device comprising at least one first processor, first processor readable media, and a first communication device configured for the first computing device to communicate over a communication network;
a second computing device comprising at least one second processor, second processor readable media and a second communication device for the second computing device to communicate over the communication network;
a display device operatively coupled to the first computing device, wherein the display device is configured to display content received from the second computing device; and
an outer frame provided in a web browser software application and displayed in the display device;
at least two inner frames contained in the outer frame, wherein the outer frame includes programming code to instruct the first at least one processor to:
make a request from a first of the at least two inner frames for first content from the second computing device over the communication network;
load the first content in the first of the at least two inner frames;
render the first of the at least two inner frames visible with the first content;
make a request from a second of the at least two inner frames for second content;
load the second content received from the second computing device over the communication network while the second of the at least two inner frames is rendered not visible;
determine whether the second of the at least two inner frames has loaded the second content; and
render the first of the at least two inner frames not visible and render the second of the at least two inner frames visible with the second content after the outer frame has determined that the second of the at least two inner frames has loaded the second content.

22. A display system, comprising:
a first computing device comprising a first at least one processor, first processor readable media, and a first communication device configured for the first computing device to communicate over a communication network;
a second computing device comprising a second at least one processor, second processor readable media and a second communication device for the second computing device to communicate over the communication network;
a display device operatively coupled to the first computing device, wherein the display device is configured to display content received from the second computing device;
an outer frame provided in a web browser software application and displayed in the display device; and
at least two inner frames contained in the outer frame, wherein the outer frame is programmed and configured to cause the first at least one processor to:
instruct a first of the at least two inner frames to load first content from the second computing device over the communication network;
instruct the first of the at least two inner frames to be rendered visible with the first content;
instruct a second of the at least two inner frames to load second content received from the second computing device over the communication network while the second of the at least two inner frames is rendered not visible;
determine whether the second of the at least two inner frames has loaded the second content; and
render the first of the at least two inner frames not visible and render the second of the at least two inner frames visible with the second content after the outer frame has determined that the second content is loaded in the second frame.
